(19) United States
(12) Patent Application Publication
(10) Pub. No.: US 2026/0019595 A1
(43) Pub. Date: Jan. 15, 2026

(54) METHOD, APPARATUS, AND MEDIUM FOR VISUAL DATA PROCESSING

(71) Applicant: Douyin Vision Co., Ltd., Beijing (CN)

(72) Inventors: Yaojun WU, Beijing (CN); Meng WANG, Beijing (CN)

(21) Appl. No.: 19/335,653

(22) Filed: Sep. 22, 2025

Related U.S. Application Data
(63) Continuation of application No. PCT/CN2024/082805, filed on Mar. 20, 2024.

(30) Foreign Application Priority Data
Mar. 22, 2023 (WO) PCT/CN2023/083198

(51) Int. Cl. H04N 19/149; G06N 3/0464; G06N 3/048

(52) U.S. Cl. CPC H04N 19/149; G06N 3/0464; G06N 3/048

(57) ABSTRACT

Embodiments of the present disclosure provide a solution for visual data processing. A method for visual data processing is proposed. In the method, for a conversion between a current visual unit of visual data and a bitstream of the visual data, a probability representation of the current visual unit is determined based on a multistage context module. The conversion is performed based on the probability representation. The multistage context module at least comprises at least one prediction fusion network. The number of convolutional layers in the at least one prediction fusion network is less than or equal to a first threshold number.

### CROSS REFERENCE TO RELATED APPLICATIONS

This application is a continuation of International Application No. PCT/CN2024/082805, filed on Mar. 20, 2024, which claims the benefit of International Application No. PCT/CN2023/083198 filed on Mar. 22, 2023. The entire contents of these applications are hereby incorporated by reference in their entireties.

### FIELDS

Embodiments of the present disclosure relates generally to visual data processing techniques, and more particularly, to multistage context module for visual data processing.

### BACKGROUND

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs. Coding efficiency of image/video coding is generally expected to be further improved.

### SUMMARY

Embodiments of the present disclosure provide a solution for visual data processing.

In a first aspect, a method for visual data processing is proposed. The method comprises: determining, for a conversion between a current visual unit of visual data and a bitstream of the visual data, a probability representation of the current visual unit based on a multistage context module; and performing the conversion based on the probability representation, wherein the multistage context module at least comprises at least one prediction fusion network, and wherein the number of convolutional layers in the at least one prediction fusion network is less than or equal to a first threshold number. In this way, the multistage context module such as a multistage context model can be simplified. The coding effectiveness and coding efficiency can thus be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for visual data processing. The method comprises: determining a probability representation of a current visual unit of the visual data based on a multistage context module; and generating the bitstream based on the probability representation, wherein the multistage context module at least comprises at least one prediction fusion network, and wherein the number of convolutional layers in the at least one prediction fusion network is less than or equal to a first threshold number.

In a fifth aspect, a method for storing a bitstream of a video is proposed. The method comprises: determining a probability representation of a current visual unit of the visual data based on a multistage context module; generating the bitstream based on the probability representation; and storing the bitstream in a non-transitory computer-readable recording medium, wherein the multistage context module at least comprises at least one prediction fusion network, and wherein the number of convolutional layers in the at least one prediction fusion network is less than or equal to a first threshold number.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates an illustration of a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model, which jointly optimizes an autoregressive component that estimates the probability distributions of latents from their causal context (Context Model) along with a hyperprior and the underlying autoencoder;

FIG. 6 illustrates an encoding process;

FIG. 7 illustrates a decoding process;

FIG. 8A and FIG. 8B illustrate diagrams of multistage context model (MCM) structure, respectively;

FIG. 9 illustrates a decoder architecture with decoupled processing;

FIG. 10A to FIG. 10C illustrate detailed structure of the multistage context model, respectively;

FIG. 11A to FIG. 11C illustrate structure of a simplified multistage context model, respectively;

FIG. 12 illustrates a flowchart of a method for visual data processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment.” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “visual data” may refer to image data or video data. The term “visual data processing” may refer to image processing or video processing. The term “visual data coding” may refer to image coding or video coding. The term “coding visual data” may refer to “encoding visual data (for example, encoding visual data into a bitstream)” and/or “decoding visual data (for example, decoding visual data from a bitstream”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”. “having”, “includes” and/or “including”, when used herein, specify the presence of stated features, elements, and/or components etc., but do not preclude the presence or addition of one or more other features, elements, components and/or combinations thereof.

### Example Environment

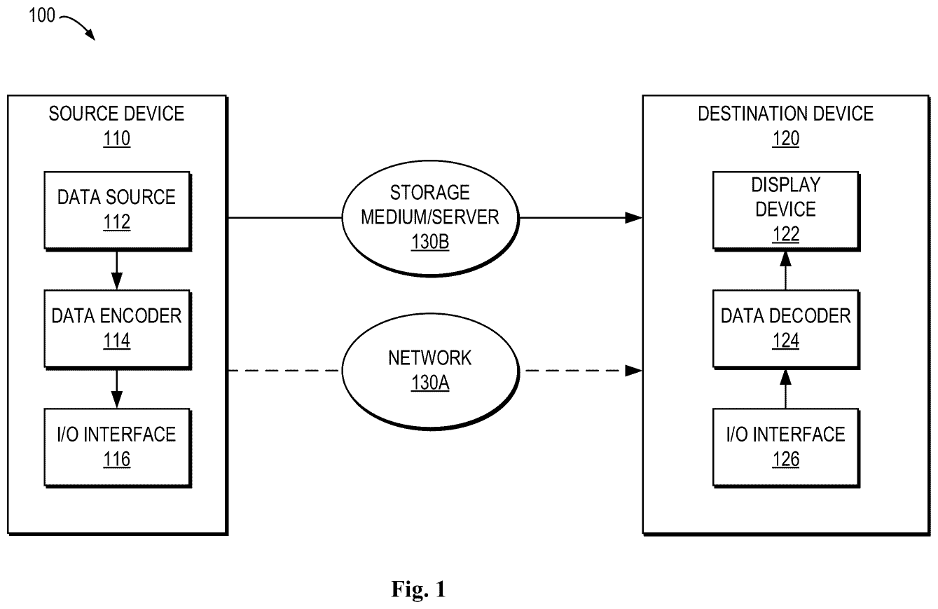

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a data encoding device or a visual data encoding device, and the destination device 120 can be also referred to as a data decoding device or a visual data decoding device. In operation, the source device 110 can be configured to generate encoded visual data and the destination device 120 can be configured to decode the encoded visual data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. Brief Summary

A neural network-based image and video compression method comprising a multi-stage context subnetwork, an entropy coding engine, wherein entropy coding is performed independently of the multi-stage context subnetwork. In this disclosure, the multistage context model is simplified to reduce the decoding complexity.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from motion picture experts group (MPEG) and Video coding experts group (VCEG). With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e., compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., discrete cosine transform (DCT) or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing in resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁. The pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented, where the feed-forward network also has connections skipping the hidden layer, and the parameters are also shared. Experiments have been performed on the binarized MNIST dataset. NADE is extended to a real-valued model RNADE, where the probability p (xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. NADE and RNADE are improved by using reorganizing the order of the pixels and with deeper neural networks.

Designing advanced neural networks plays an important role in improving pixel probability modeling. Multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later. Several different neural networks are studied, including RNNs and CNNs namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1 . . . 255) and predict a multinomial distribution over the discrete values; they deal with color images in RGB color space; they work well on large-scale image dataset ImageNet. Gated PixelCNN is proposed to improve the PixelCNN, and achieves comparable performance with PixelRNN but with much less complexity. PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. PixelSNAIL is proposed, in which casual convolutions are combined with self-attention.

Most of the above methods directly model the probability distribution in the pixel domain. Some researchers also attempt to model the probability distribution as a conditional one upon explicit or latent representations. That being said, it may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder is proposed. The method for the auto-encoder is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

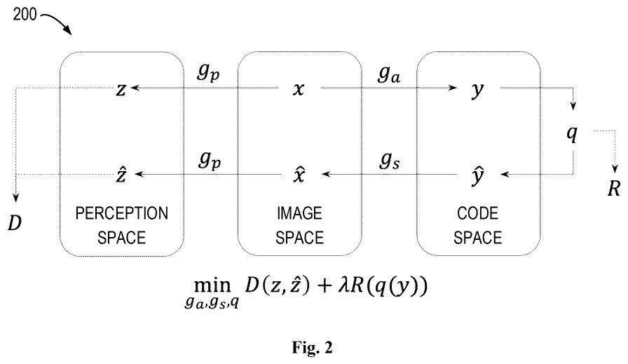

FIG. 2 illustrates an illustration of a typical transform coding scheme 200. The original image x is transformed by the analysis network gₐ to achieve the latent representation y. The latent representation y is quantized and compressed into bits. The number of bits R is used to measure the coding rate. The quantized latent representation § is then inversely transformed by a synthesis network gₛ to obtain the reconstructed image x. The distortion is calculated in a perceptual space by transforming x and x with the function gₚ.

It is intuitive to apply auto-encoder network to lossy image compression. The learned latent representation may be encoded from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+ΔR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, a general framework for variable rate image compression using RNN is proposed. Binary quantization is used to generate codes and do not consider rate during training. The framework indeed provides a scalable coding functionality, where RNN with convolutional and deconvolution layers is reported to perform decently. An improved version by upgrading the encoder with a neural network similar to PixelRNN to compress the binary codes is then proposed. The performance is reportedly better than JPEG on Kodak image dataset using MS-SSIM evaluation metric. The RNN-based solution is further improved by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Spatially adaptive bitrates are supported by training stop-code tolerant RNNs.

A general framework for rate-distortion optimized image compression is proposed. The use multinary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified. An improved version is then proposed, where they use 3 convolutional layers each followed by a down-sampling layer and a GDN layer as the forward transform.

Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, they improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. The structures are further exploited in the residue space by introducing an autoregressive model to estimate both the standard deviation and the mean. Z. Gaussian mixture model is used to further remove redundancy in the residue. The reported performance is on par with VVC on the Kodak image set using PSNR as evaluation metric.

### 2.3.3 Hyper Prior Model

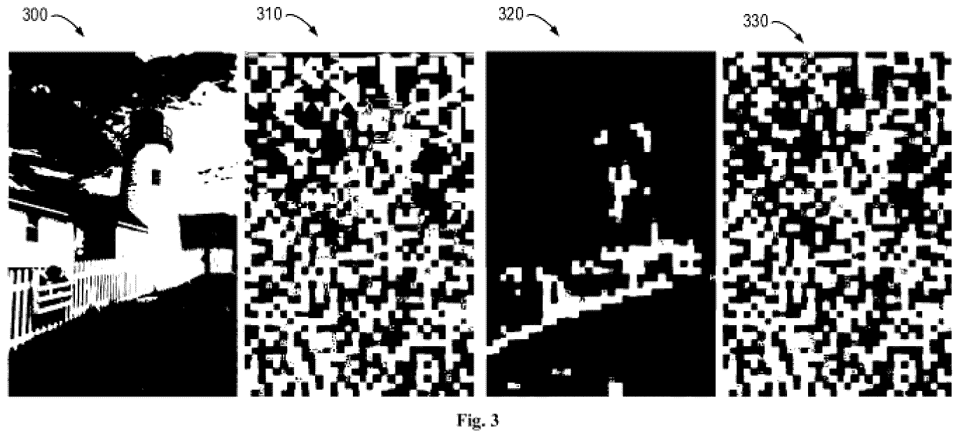

FIG. 3 illustrates example latent representations of an image, including an image 300 from the Kodak dataset, a visualization of the latent 310 representation y of the image 300, a standard deviations σ 320 of the latent 310, and latents y 330 after a hyper prior network is introduced. A hyper prior network includes a hyper encoder and decoder. In the transform coding approach to image compression, the encoder subnetwork (section 2.3.2) transforms the image vector x using a parametric analysis transform gₐ (x, Ø_{g}) into a latent representation y, which is then quantized to form ŷ. Because ŷ is discrete-valued, it can be losslessly compressed using entropy coding techniques such as arithmetic coding and transmitted as a sequence of bits.

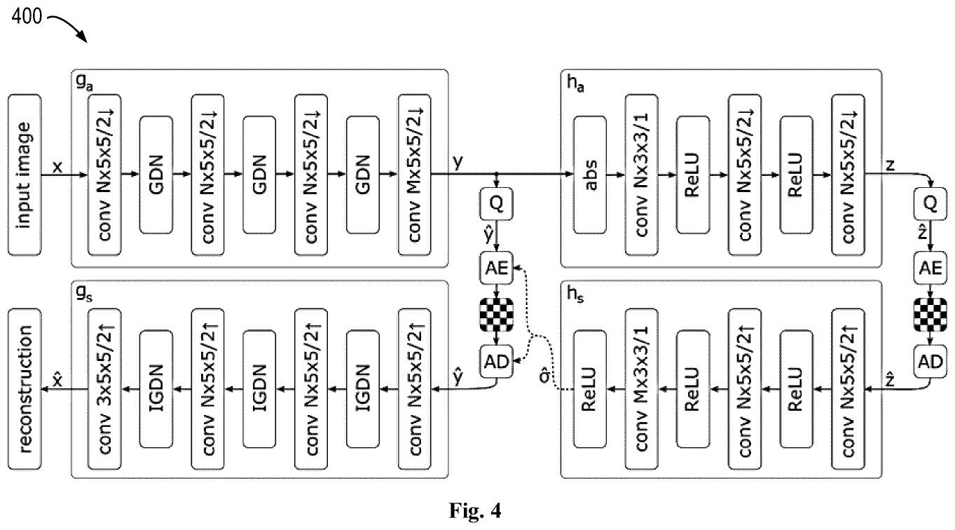

As evident from the latent 310 and the standard deviations σ 320 of FIG. 3, there are significant spatial dependencies among the elements of ŷ. Notably, their scales (middle right image) appear to be coupled spatially. An additional set of random variables \hat{z} are introduced to capture the spatial dependencies and to further reduce the redundancies. In this case the image compression network is depicted in FIG. 4.

FIG. 4 is a schematic diagram 400 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In FIG. 4, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.

When the hyper encoder and hyper decoder are added to the image compression network, the spatial redundancies of the quantized latent y are reduced. The rightmost image (that is, the latents y 330) in FIG. 3 correspond to the quantized latent when hyper encoder/decoder are used. Compared to middle right image (that is, the standard deviations σ 320), the spatial redundancies are significantly reduced, as the samples of the quantized latent are less correlated.

### 2.3.4 Context Model

Although the hyperprior model improves the modelling of the probability distribution of the quantized latent y, additional improvement can be obtained by utilizing an autoregressive model that predicts quantized latents from their causal context (Context Model).

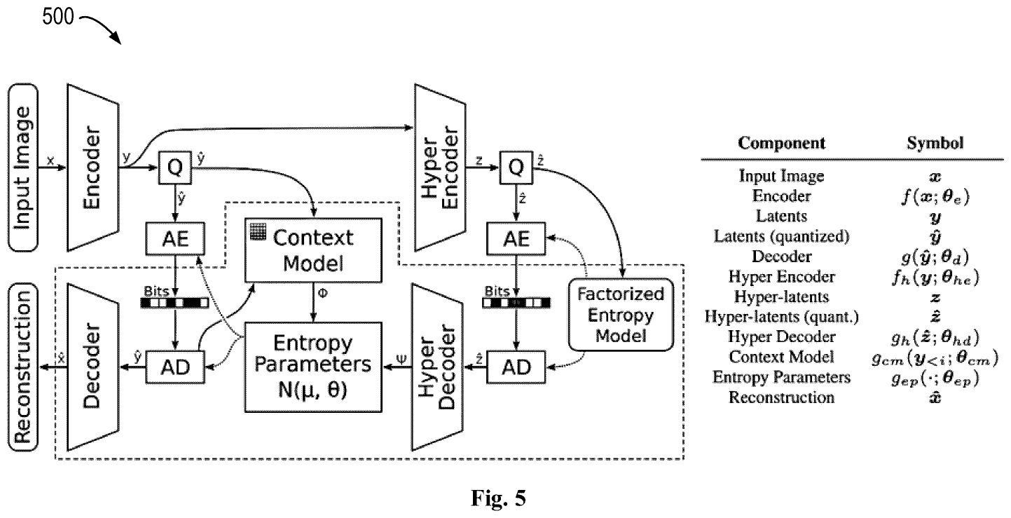

The term auto-regressive means that the output of a process is later used as input to it. For example, the context model subnetwork generates one sample of a latent, which is later used as input to obtain the next sample. FIG. 5 is a schematic diagram 500 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

A joint architecture where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 5, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

Typically the latent samples are modeled as gaussian distribution or gaussian mixture models (not limited to). In FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 The Encoding Process Using Joint Auto-Regressive Hyper Prior Model

The FIG. 5. corresponds to the compression method using joint auto-regressive hyper prior model. In this section and the next, the encoding and decoding processes will be described separately.

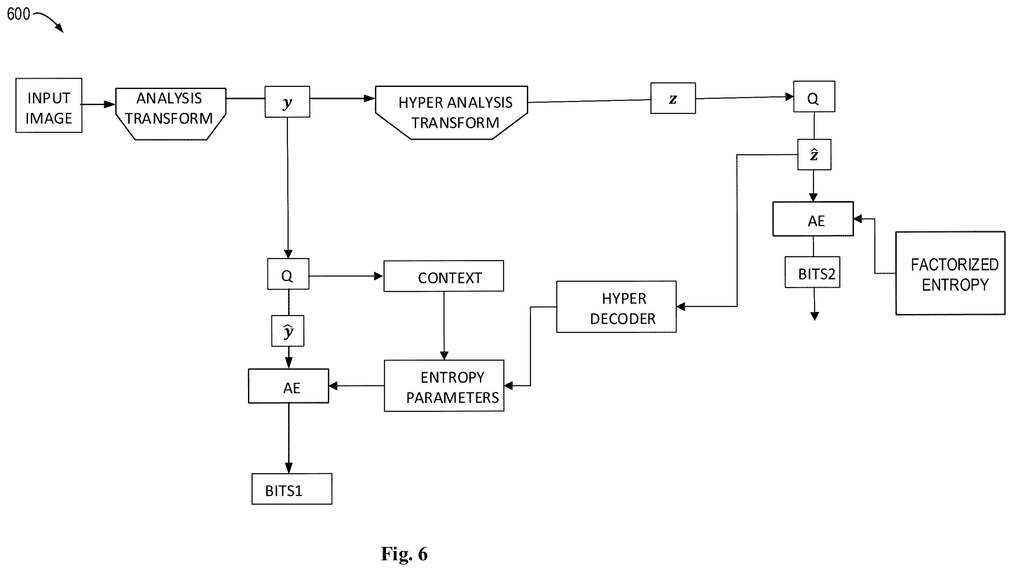

FIG. 6 depicts an encoding process 600. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 6 are collectively called encoder. The analysis transform that converts the input image into latent representation is also called an encoder (or auto-encoder).

### 2.3.6 the Decoding Process Using Joint Auto-Regressive Hyper Prior Model

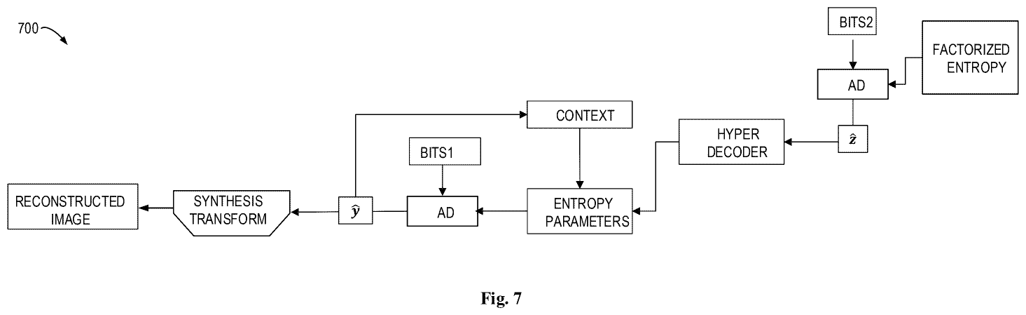

FIG. 7 depicts a decoding process 700 separately corresponding to the encoding process 600.

In the decoding process 700, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent y is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4. Multistage Context Model for Entropy Probability Modeling

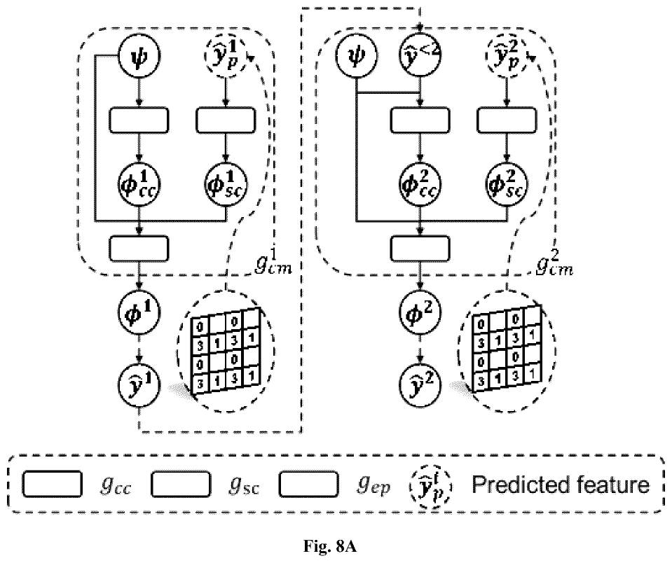

In section 2.3.4, pixel CNN is employed as the context model to further build the relationship between different models, which provides better coding performance through the will designed context modeling. However, it limits the throughput of the probability prediction, because there is a strong dependence on the probability modeling of the elements, it needs to be decoded serially one by one, which might be a nightmare for high resolution images. To solve these issues, a multistage context model is proposed as the replacement of the context model, it provides better parallelism in GPU calculation and greatly reduces the decoding time of high-resolution images. FIG. 8A and FIG. 8B show a structure of the multistage context model, respectively. Specifically, the Multistage Context model divided the latent information into 2 groups in channel dimension, as shown in FIG. 8A.

After splitting the channel dimension, for latent of each group, 4-stage context modeling will be applied to build context information for latent elements. The shape of the context modeling is provided in FIG. 8B.

Benefit from the design of the multistage context model, the times of the context prediction process is no longer dependent on the resolution of the input image, it comes to be a fixed number. In this design, we only need to perform the context prediction process 8 times, so that the decoding time is much faster than the original autoregressive context model.

### 2.5. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5.1 Low-Latency

A video compression scheme with trained neural networks is proposed. The video sequence frames are split into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method. Another neural network-based video coding scheme with PixelMotionCNN is proposed. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

A real-sense end-to-end neural network-based video compression framework is proposed, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

An advanced neural network-based video compression scheme is proposed. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

An extended end-to-end neural network-based video compression framework based on is proposed. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than and H.265 by a noticeable margin in terms of both PSNR and MS-SSIM.

A scale-space flow is proposed to replace commonly used optical flow by adding a scale parameter based on framework of. It is reportedly achieving better performance than H.264.

It is proposed a multi-resolution representation for optical flows. Concretely, the motion estimation network produces multiple optical flows with different resolutions and let the network to learn which one to choose under the loss function. The performance is slightly improved compared with and better than H.265.

### 2.5.2 Random Access

A neural network-based video compression scheme with frame interpolation is proposed. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

A method for interpolation-based video compression is proposed, wherein the interpolation model combines motion information compression and image synthesis, and the same auto-encoder is used for image and residual. A neural network-based video compression method based on variational auto-encoders with a deterministic encoder is proposed. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.6. Preliminaries

Almost all the natural image/video is in digital format. A grayscale digital image can be represented by x E [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( ) )}^{2}}{MSE} \qquad ( 5 )$$

where max ( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 3. Problems

### 3.1. The Core Problem

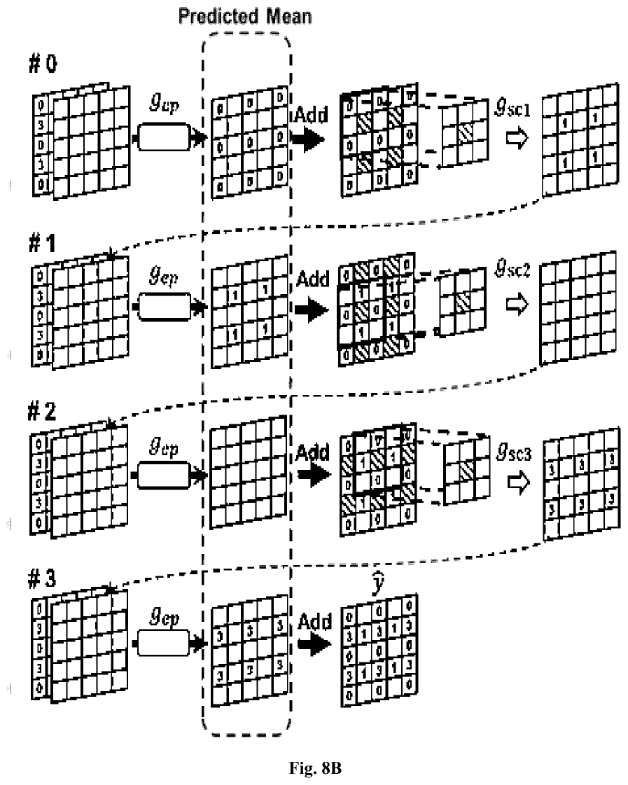

FIG. 9 illustrates a decoder architecture with decoupled processing. As illustrated in FIG. 9, the decoder with decoupled processing decouples the arithmetic decoding process (the process of receiving bits and generates ŵ) from the context prediction loop (the combined module comprising hyper decoder, Multistage Context model). To further reduce the decoding complexity, multistage context model is employed as a replacement of the context, which already provides faster decoding time speed up than autoregressive context model. However, to meet the requirements of the hardware, current multistage context model still needs to be simplified. Based on our complexity result, current multistage context model may need 35 kMac/pxl to realize the decoding process, while the requirement of the hardware device might be below 10 kMac/pxl. And existing methods have not tried to simplify the multistage context model to reduce the complexity. Meanwhile, the challenge of the complexity reduction is the trade-off between the coding performance and complexity. It is known that decreasing complexity might always bring coding loss, how to design a light weighted model to maintain coding performance while minimizing complexity is still a problem.

### 3.2. Background and Details of the Problem

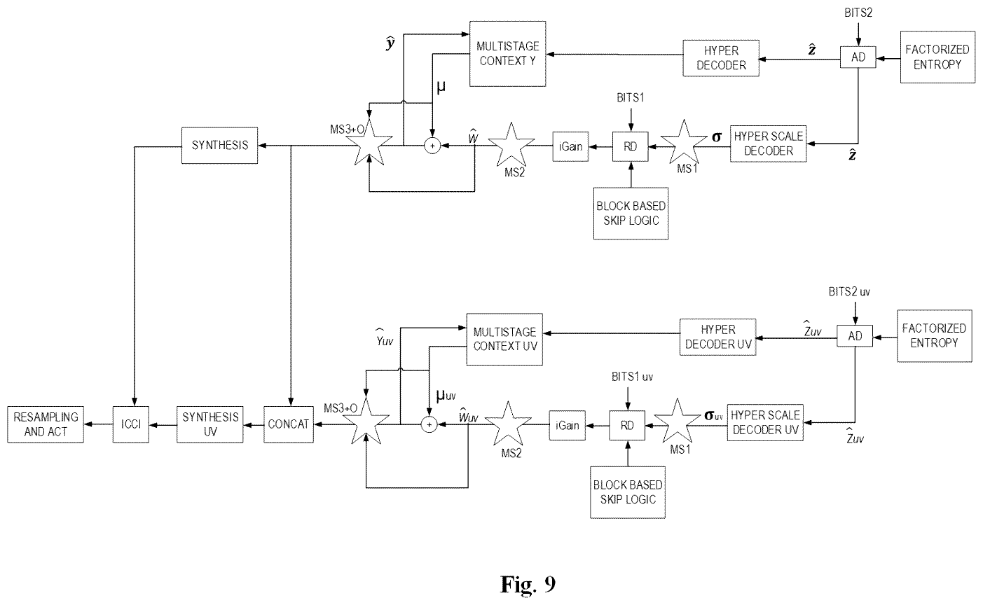

As illustrated in FIG. 8A and FIG. 8B, the original design of the multistage context model involves conditional context net g_cc, four stage context network g_sc, and embedding prediction fusion network g_ep. The detailed structure of current multistage context model is illustrated in FIG. 10A to FIG. 10C. FIG. 10A illustrates the structure of g_cc in the multistage context model. FIG. 10B illustrates the structure of g_sc in the multistage context model. FIG. 10C illustrates the structure of g_ep in the multistage context model.

To simplify the complexity of the multistage context model, all these three parts needs to be simplified. In addition, in case the performance might drop, modifications on the stage context network can be applied to compensate the performance drop.

### 4. Detailed Solutions

The detailed embodiments below should be considered as examples to explain general concepts. These embodiments should not be interpreted in a narrow way. Furthermore, these embodiments can be combined in any manner.

### 4.1. Core of the Solutions

The target of the invention is to simplify the multistage context model (including the conditional context net g_cc, four stage context network g_sc, and embedding prediction fusion network g_ep) while maintaining the coding performance as much as possible. Specifically, the invention might reduce the number of the convolution layers, adjusting the number of channels, modify the kernel size of the convolution layers to simplify the conditional context net g_cc and embedding prediction fusion network g_ep. Furthermore, to maintain the coding performance and reduce the complexity, the invention might modify the kernel size, design new mask patterns or reduce channel numbers for the stage context network.

The following examples shows the possible ways to simplify the network architecture of g_cc, g_sc and g_ep.

Example 1: remove one convolutional layer from the g_cc and g_ep. The last convolutional layer is removed as illustrated followed by changing the number of last convolutional layer output channels to C.

Example 2: remove multiple convolutional layers from the g_cc or g_ep.

Example 3: remove multiple convolutional layers from the g_cc or g_ep and change the number of channels. It is possible to increase the number of channels for each convolutional layers without impacting the decoding time. And, in this example, adjusting the number of channels include both increasing and decreasing the number of channels.

Example 4: modifications can be applied to the g_cc or g_ep with anyone from Example 1-3 or any combinations of them. Modifying the g_cc or g_ep could be adding one or more convolutional layers, adjusting the number channels, modifying the activation layers, replacing one or more convolutional layer(s) with one or more new convolutional layer(s). The objective is to compensate the possible coding efficiency drop resulting from simplifying the g_cc or g_ep.

Example 5: modification can be applied to the g_sc. Kernel size might be increased in g_sc to improve the context modeling ability.

Example 6: new multistage mask convolution pattern might be designed to compensate the coding loss that caused during the simplification of the multistage context model.

Example 7: channel number of the g_sc might be reduced to reduce the complexity, the channel of the input and the output might need to be modified accordingly. Moreover, the channel number of the g_sc might be increased due to the change of the input information.

Example 8: modification can be applied to the g_sc with anyone from Example 5-7 or any combinations of them. The abovementioned examples can be combined in any manner. Other modifications can also be made, such as changing the Context Model Net, as long as the decoding complexity can be reduced without impacting the coding efficiency.

### 4.2. Details of Embodiments

1. The conditional context net g_cc can be modified to simplify the multistage context model.
   a) In one example, for the two groups of latent grouped by the channel dimension, g_cc with the same structure and different weights will be used to process the latent of their respective groups.
   b) In one example, for the two groups of latent grouped by the channel dimension, g_cc with the same structure and same weights will be used to process both of these latent.
   c) In one example, one or more layers could be removed from g_cc.
   d) In one example, after removing some layers, the number of channels can be adjusted accordingly.
   e) In one example, one or more of the layers can be replaced with one or more new layers.
   f) In one example, the kernel size of the convolution layers might be changed from 5×5 to 4×4 to reduce the complexity of the network.
   g) In one example, the kernel size of the convolution layers might be changed from 3×3 to 4×4 to compensate the coding loss that caused by the simplification.
   h) In one example, the number of channels can be adjusted accordingly.
      i. The number of channels of all or partial of the convolutional layers can be adjusted to be multiple of M, e.g. M=16 or 32.
      ii. The number of channels of all or partial of the convolutional layers can be adjusted to be the power of 2, i.e., 2ⁿ where n=1, 2, 3, . . . .
   i) In one example, the activation function inside the g_cc might be replaced to a unified activation function.
      i. In one example, the unified activation function might be ReLU.
      ii. In one example, the unified activation function might be LeakyReLU.
      iii. In one example, the unified activation function might be GELU.
      iv. In one example, the unified activation function might be Sigmoid.
   j) In one example, multiple g_cc architectures could exist in the decoder and a syntax element (SE) such as a flag may be signaled in the bitstreams to indicate which one is used.
   k) In one example, a SE is used to indicate how many g_cc architectures are involved in the decoder.
   l) In one example, one flag may be used to indicate whether the g_cc or the original design is used.
   m) In one example, the modified g_cc can be applied to either luma or chroma or both.
2. The four-stage context network g_sc can be modified to simplify the multistage context model or compensate the performance loss that caused by simplication.
   a) In one example, the kernel size of the g_sc might be changed from 3×3 to 4×4 to improve the coding performance.
   b) In one example, four-stage context network might be changed to nine stage to improve the context probability modeling process.
   c) In one example, the channel number of the g_sc might be modified to reduce the complexity.
3. The embedding prediction fusion network g_ep can be modified to simplify the multistage context model.
   a) In one example, for the latent in different stage, g_ep will be the same structure, and the weights might be individual for each stage operation.
   b) In one example, for the latent in different stage, g_ep will be the same structure, and the weights is also identical for each stage operation.
   c) In one example, one or more layers could be removed from g_ep.
   d) In one example, after removing some layers, the number of channels can be adjusted accordingly.
   e) In one example, one or more of the layers can be replaced with one or more new layers.
   f) In one example, the number of channels can be adjusted accordingly.
      iii. The number of channels of all or partial of the convolutional layers can be adjusted to be multiple of M, e.g. M=16 or 32.
      iv. The number of channels of all or partial of the convolutional layers can be adjusted to be the power of 2, i.e., 2ⁿ where n=1, 2, 3, . . . .
   g) In one example, the activation function inside the g_ep might be replaced to a unified activation function.
      i. In one example, the unified activation function might be ReLU.
      ii. In one example, the unified activation function might be LeakyReLU.
      iii. In one example, the unified activation function might be GELU.
      iv. In one example, the unified activation function might be Sigmoid.
   h) In one example, multiple g_ep architectures could exist in the decoder and a syntax element (SE) such as a flag may be signaled in the bitstreams to indicate which one is used.
   i) In one example, a SE is used to indicate how many g_ep architectures are involved in the decoder.
   j) In one example, one flag may be used to indicate whether the g_ep or the original design is used.
   k) In one example, the modified g_ep can be applied to either luma or chroma or both.
4. In one example, to reduce the kMAC in implementation, the stride of the convolution might be 2/3/ . . . to skip unnecessary convolution calculation.

### General

1. Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
2. Whether to and/or how to apply the disclosed methods above may be dependent on coded information, such as block size, colour format, single/dual tree partitioning, colour component, slice/picture type.
3. The proposed methods disclosed in this document may be used in other coding tools which require chroma fusion.
4. A syntax element disclosed above may be binarized as a flag, a fixed length code, an EG(x) code, a unary code, a truncated unary code, a truncated binary code, etc. It can be signed or unsigned.
5. A syntax element disclosed above may be coded with at least one context model. Or it may be bypass coded.
6. A syntax element disclosed above may be signaled in a conditional way.
   a. The SE is signaled only if the corresponding function is applicable.
   b. The SE is signaled only if the dimensions (width and/or height) of the block satisfy a condition.
7. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.

### 4.3. Benefit

According to the invention, the component (conditional context net g_cc, four stage context network g_sc, and embedding prediction fusion network g_ep) of the multistage context model are simplified to meet the requiement of the hardware devices and speed up the total decoding time. In addition, new design for four-stage context network g_sc is proposed to compensate the coding loss. At the end, this invention greatly reduced the decoding complexity while maintaining or outperforming the original design in terms of coding efficiency.

### 5. Further Embodiments

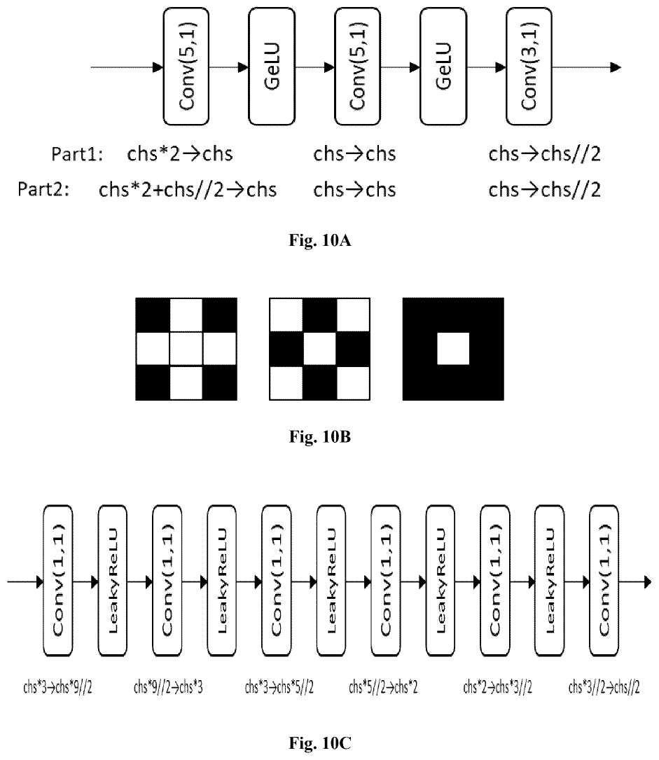

The simplified multistage context model can be approached from three aspects: 1) simplifying the conditional context net g_cc. 2) Enhancing four stage context network g_sc. 3) simplifying the embedding prediction fusion network g_ep. FIG. 11A to FIG. 11C depict an example of the simplified multistage context model. FIG. 11A illustrates the structure of the simplified g_cc in the simplified multistage context model. FIG. 11B illustrates the structure of the simplified g_sc in the simplified multistate context model. FIG. 11C illustrates the structure of the simplified g_ep in the simplified multistate context model.

In conditional context net g_cc, we increase the kernel size of the convolution from 3×3 to 4×4 to improve the coding performance. And the activation function is replaced with ReLU. In four stage context network g_sc, the kernel size of the context model is increased to 4×4, in this cases, we modified the pattern of the mask convolution to obtain more context information so that the coding performance can be further improved. In the structure of the embedding prediction fusion network g_ep, we reduced three convolution layers, and the channel number is reduced faster to reduce the complexity.

The core idea is that using signaling in the bitstream to indicate whether a subnetwork is used or not.

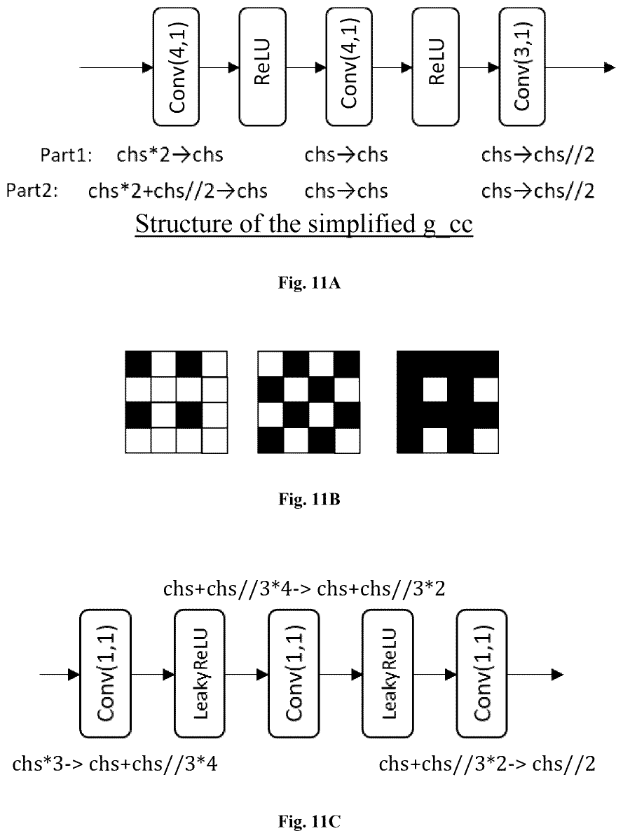

Further details will be described below. FIG. 12 illustrates a flowchart of a method 1200 for visual data processing in accordance with embodiments of the present disclosure. The method 1200 is implemented for a conversion between a current visual unit of visual data and a bitstream of the visual data.

At block 1210, a probability representation of the current visual unit is determined based on a multistage context module. As used herein, the term “multistate context module” may also be referred to as a “multimedia context model” or a “neural network (NN) based multistage context module”. The multistage context module at least comprises at least one prediction fusion network, such as the simplified g_ep as shown in FIG. 11C or any other suitable prediction fusion network. The number of convolutional layers in the at least one prediction fusion network is less than or equal to a first threshold number. The threshold number may be predetermined or configured. For example, the threshold number may be the number of convolutional layers in a conventional g_ep, such as the number of convolutional layers in the g_ep in FIG. 10C.

At block 1220, the conversion is performed based on the probability representation. For example, the conversion is performed by a NN-based coding system including the multistage context module, such as an end-to-end image and video compression system. The NN-based coding system may be similar to the coding system as shown in FIG. 9. For example, the multistage context module may be used for the multistage context Y and/or the multistage context UV as shown in FIG. 9. The probability representation output by the multistage context module may be u or uuv as shown in FIG. 9.

The method 1200 enables applying a simplified multistage context module for the visual data processing. For example, the number of convolutional layers in the multistage context module may be reduced. The coding effectiveness and coding efficiency can thus be improved.

In some embodiments, the number of channels in at least one convolutional layer in the at least one prediction fusion network is less than or equal to a second threshold number. The second threshold number may be predetermined or configured. For example, the second threshold number may be the number of channels in a convolutional layer in the g_ep in FIG. 10C. That is, the number of channels in the convolutional layer may be reduced.

Alternatively, in some embodiments, the number of channels in at least one convolutional layer in the at least one prediction fusion network is larger than or equal to the second threshold number. That is, the number of channels in the convolutional layer may be increased.

In some embodiments, at least one activation layer in the at least one prediction fusion network is different from a first activation layer. For example, the first activation layer may be the activation layer in g_ep in FIG. 10C.

In some embodiments, the at least one activation layer comprises a unified activation function, the unified activation function comprising one of: ReLU, LeakyReLU, GELU, or Sigmoid.

In some embodiments, at least one parameter of the at least one convolutional layer in the at least one prediction fusion network is different from at least one parameter of a first convolutional layer. That is, a convolutional layer may be replaced by a new convolutional layer.

In some embodiments, the at least one prediction fusion network comprises a plurality of prediction fusion networks for a plurality of stages, and structures of the plurality of prediction fusion networks are same.

In some embodiments, for visual data representations in the plurality of stages, weights of the plurality of prediction fusion networks are different for respective stage operations. Alternatively, in some embodiments, for visual data representations in the plurality of stages, weights of the plurality of prediction fusion networks are same for respective stage operations.

In some embodiments, at least one layer in a prediction fusion network of the plurality of prediction fusion networks may be removed.

In some embodiments, the number of channels of at least one convolutional layer in the plurality of prediction fusion networks is a multiple of a positive integer. By way of example, the positive integer may be 16 or 32.

In some embodiments, the number of channels of at least one convolutional layer in the plurality of prediction fusion networks is 2ⁿ, n being a positive integer.

In some embodiments, a plurality of prediction fusion network structures is supported, a first syntax element in the bitstream indicating a target prediction fusion network structure of the plurality of prediction fusion network structures to be used for the at least one prediction fusion network.

In some embodiments, a second syntax element in the bitstream indicated the number of the plurality of prediction fusion network structures.

In some embodiments, a syntax element in the bitstream indicates whether to use the at least one prediction fusion network or a further prediction fusion network with a structure different from the at least one prediction fusion network.

In some embodiments, a flag in the bitstream indicates that the at least one prediction fusion network is applied to at least one of: luma or chroma.

In some embodiments, the multistage context module further comprises at least one multistage context network. For example, the multistage context network may be the g_sc in FIG. 11B or any other suitable multistage context network.

In some embodiments, the number of channels in the at least one multistage context network is less than or equal to a third threshold number. The third threshold number may be predetermined or configured. For example, the third threshold number may be the number of channels in the g_sc om FIG. 10B.

In some embodiments, an input channel and an output channel of the multistage context network is updated.

In some embodiments, the number of channels is updated based on a change of input information.

In some embodiments, a kernel size of the at least one multistage context network is greater than or equal to a threshold size. The threshold size may be predetermined or configured. For example, the threshold size may be the kernel size of g_sc in FIG. 10B. That is, the kernel size may be increased. By way of example, the kernel size may be 4×4.

In some embodiments, the at least one multistage context network applies a first multistage mask convolutional pattern different from a second multistage mask convolutional pattern. That is, new multistage mask convolution pattern might be designed to compensate the coding loss that caused during the simplification of the multistage context model.

In some embodiments, the multistage context network comprises four stages or nine stages.

In some embodiments, the multistage context module further comprises a conditional context network, such as the simplified g_cc as shown in FIG. 11A or any other suitable conditional context network. The number of convolutional layers in the conditional context network is less than or equal to a fourth threshold number. The fourth threshold number may be predetermined or configured. For example, the fourth threshold number may be the number of convolutional layers in the g_cc in FIG. 10A.

In some embodiments, the number of channels in at least one convolutional layer in the conditional context network is less than or equal to a threshold number. The threshold number may be the number of channels in a convolutional layer in g_cc in FIG. 10A. That is, the number of channels in the conditional context network may be reduced.

Alternatively, in some embodiments, the number of channels in at least one convolutional layer in the conditional context network is larger than or equal to the threshold number. That is, the number of channels in the conditional context network may be increased.

In some embodiments, the number of channels in at least one convolutional layer in the conditional context network is one of: a multiple of M, M being 16 or 32, or 2″, n being a positive integer.

In some embodiments, at least one activation layer in the conditional context network is different from a first activation layer. The first activation layer may be the activation layer in the g_cc in FIG. 10A.

In some embodiments, the at least one activation layer in the conditional context network may be a unified activation function, the unified activation function comprising one of: ReLU, LeakyReLU, GELU, or Sigmoid.

In some embodiments, at least one parameter of at least one convolutional layer in the conditional context network is different from at least one parameter of a first convolutional layer. The first convolutional layer may be the convolutional layer in g_cc in FIG. 10A. That is, the convolutional layer may be replaced by a new convolutional layer.

In some embodiments, for a plurality of groups of latents grouped by a channel dimension, the conditional context network with a same structure and different weights is used to process latents of respective groups.

Alternatively, in some embodiments, for a plurality of groups of latents grouped by a channel dimension, the conditional context network with a same structure and same weights is used to process latents of respective groups.

In some embodiments, a kernel size of a convolutional layer in the conditional context network comprises 4×4.

In some embodiments, a plurality of conditional context network structures is supported, a syntax element in the bitstream indicating a target conditional context network structure to be used for the conditional context network.

In some embodiments, a further syntax element in the bitstream indicated the number of the plurality of conditional context network structures.

In some embodiments, a syntax element in the bitstream indicates whether to use the conditional context network or a further conditional context network with a structure different from the conditional context network.

In some embodiments, a flag in the bitstream indicates that the conditional context network is applied to at least one of: luma or chroma.

In some embodiments, a stride of convolution of at least one convolutional layer in the multistage context module is an integer greater than or equal to 2.

In some embodiments, the conversion may comprise decoding the current visual unit from the bitstream. Alternatively, or in addition, the conversion may comprise encoding the current visual unit into the bitstream.

In some embodiments, information regarding whether to and/or how to apply the method 1200 is indicated at at least one of: a block level, a sequence level, a group of pictures level, a picture level, a slice level, or a tile group level.

In some embodiments, information regarding whether to and/or how to apply the method 1200 is included in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

In some embodiments, information regarding whether to and/or how to apply the method 1200 is based on coded information, the coded information comprising at least one of: a block size, a color format, a single or dual tree partitioning, a color component, a slice type or a picture type.

In some embodiments, the method 1200 is used in a coding tool requires chroma fusion.

In some embodiments, a syntax element in the bitstream is binarized as at least one of: a flag, a fixed length code, an exponential Golomb (EG) (x) code, a unary code, a truncated unary code, or a truncated binary code. In some embodiments, the syntax element is signed or unsigned.

In some embodiments, a syntax element in the bitstream is coded with at least one context model, or bypass coded.

In some embodiments, a syntax element is included in the bitstream based on a condition, the condition comprising at least one of: that a function associated with the syntax element is applicable, or that a dimension of the current video block satisfied a dimension condition.

In some embodiments, a syntax element in the bitstream is at at least one of: a block level, a sequence level, a group of pictures level, a picture level, a slice level, or a tile group level.

In some embodiments, a syntax element in the bitstream is included in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

According to further embodiments of the present disclosure, a non-transitory computer-readable recording medium is provided. The non-transitory computer-readable recording medium stores a bitstream of a video which is generated by a method performed by an apparatus for visual data processing. In the method, a probability representation of a current visual unit of the visual data is determined based on a multistage context module. The bitstream is generated based on the probability representation. The multistage context module at least comprises at least one prediction fusion network. The number of convolutional layers in the at least one prediction fusion network is less than or equal to a first threshold number.

According to still further embodiments of the present disclosure, a method for storing bitstream of a video is provided. In the method, a probability representation of a current visual unit of the visual data is determined based on a multistage context module. The bitstream is generated based on the probability representation. The bitstream is stored in a non-transitory computer-readable recording medium. The multistage context module at least comprises at least one prediction fusion network. The number of convolutional layers in the at least one prediction fusion network is less than or equal to a first threshold number.

Implementations of the present disclosure can be described in view of the following clauses, the features of which can be combined in any reasonable manner.

Clause 1. A method for visual data processing, comprising: determining, for a conversion between a current visual unit of visual data and a bitstream of the visual data, a probability representation of the current visual unit based on a multistage context module; and performing the conversion based on the probability representation, wherein the multistage context module at least comprises at least one prediction fusion network, and wherein the number of convolutional layers in the at least one prediction fusion network is less than or equal to a first threshold number.

Clause 2. The method of clause 1, wherein the number of channels in at least one convolutional layer in the at least one prediction fusion network is less than or equal to a second threshold number.

Clause 3. The method of clause 1, wherein the number of channels in at least one convolutional layer in the at least one prediction fusion network is larger than or equal to a second threshold number.

Clause 4. The method of any of clauses 1-3, wherein at least one activation layer in the at least one prediction fusion network is different from a first activation layer.

Clause 5. The method of clause 4, wherein the at least one activation layer comprises a unified activation function, the unified activation function comprising one of: ReLU, LeakyReLU, GELU, or Sigmoid.

Clause 6. The method of any of clauses 1-5, wherein at least one parameter of the at least one convolutional layer in the at least one prediction fusion network is different from at least one parameter of a first convolutional layer.

Clause 7. The method of any of clauses 1-6, wherein the at least one prediction fusion network comprises a plurality of prediction fusion networks for a plurality of stages, and structures of the plurality of prediction fusion networks are same.

Clause 8. The method of clause 7, wherein for visual data representations in the plurality of stages, weights of the plurality of prediction fusion networks are different for respective stage operations.

Clause 9. The method of clause 7, wherein for visual data representations in the plurality of stages, weights of the plurality of prediction fusion networks are same for respective stage operations.

Clause 10. The method of any of clauses 7-9, wherein at least one layer in a prediction fusion network of the plurality of prediction fusion networks is removed.

Clause 11. The method of any of clauses 7-9, wherein the number of channels of at least one convolutional layer in the plurality of prediction fusion networks is a multiple of a positive integer.

Clause 12. The method of clause 11, wherein the positive integer is 16 or 32.

Clause 13. The method of any of clauses 7-9, wherein the number of channels of at least one convolutional layer in the plurality of prediction fusion networks is 2n, n being a positive integer.

Clause 14. The method of any of clauses 1-13, wherein a plurality of prediction fusion network structures is supported, a first syntax element in the bitstream indicating a target prediction fusion network structure of the plurality of prediction fusion network structures to be used for the at least one prediction fusion network.

Clause 15. The method of clause 14, wherein a second syntax element in the bitstream indicated the number of the plurality of prediction fusion network structures.

Clause 16. The method of any of clauses 1-15, wherein a syntax element in the bitstream indicates whether to use the at least one prediction fusion network or a further prediction fusion network with a structure different from the at least one prediction fusion network.

Clause 17. The method of any of clauses 1-16, wherein a flag in the bitstream indicates that the at least one prediction fusion network is applied to at least one of: luma or chroma.

Clause 18. The method of any of clauses 1-17, wherein the multistage context module further comprises at least one multistage context network.

Clause 19. The method of clause 18, wherein the number of channels in the at least one multistage context network is less than or equal to a third threshold number.

Clause 20. The method of clause 19, wherein an input channel and an output channel of the multistage context network is updated.

Clause 21. The method of clause 19, wherein the number of channels is updated based on a change of input information.

Clause 22. The method of any of clauses 18-21, wherein a kernel size of the at least one multistage context network is greater than or equal to a threshold size.

Clause 23. The method of clause 22, wherein the kernel size is 4×4.

Clause 24. The method of any of clauses 18-23, wherein the at least one multistage context network applies a first multistage mask convolutional pattern different from a second multistage mask convolutional pattern.

Clause 25. The method of any of clauses 18-24, wherein the multistage context network comprises four stages or nine stages.

Clause 26. The method of any of clauses 1-25, wherein the multistage context module further comprises a conditional context network, and wherein the number of convolutional layers in the conditional context network is less than or equal to a fourth threshold number.

Clause 27. The method of clause 26, wherein the number of channels in at least one convolutional layer in the conditional context network is less than or equal to a threshold number.

Clause 28. The method of clause 26, wherein the number of channels in at least one convolutional layer in the conditional context network is larger than or equal to a threshold number.

Clause 29. The method of clause 26, wherein the number of channels in at least one convolutional layer in the conditional context network is one of: a multiple of M, M being 16 or 32, or 2n, n being a positive integer.

Clause 30. The method of any of clauses 26-29, wherein at least one activation layer in the conditional context network is different from a first activation layer.

Clause 31. The method of clause 30, wherein the at least one activation layer comprises a unified activation function, the unified activation function comprising one of: ReLU, LeakyReLU, GELU, or Sigmoid.

Clause 32. The method of any of clauses 26-31, wherein at least one parameter of at least one convolutional layer in the conditional context network is different from at least one parameter of a first convolutional layer.

Clause 33. The method of any of clauses 26-21, wherein for a plurality of groups of latents grouped by a channel dimension, the conditional context network with a same structure and different weights is used to process latents of respective groups.

Clause 34. The method of any of clauses 26-21, wherein for a plurality of groups of latents grouped by a channel dimension, the conditional context network with a same structure and same weights is used to process latents of respective groups.

Clause 35. The method of any of clauses 26-34, wherein a kernel size of a convolutional layer in the conditional context network comprises 4×4.

Clause 36. The method of any of clauses 26-35, wherein a plurality of conditional context network structures is supported, a syntax element in the bitstream indicating a target conditional context network structure to be used for the conditional context network.

Clause 37. The method of clause 36, wherein a further syntax element in the bitstream indicated the number of the plurality of conditional context network structures.

Clause 38. The method of any of clauses 26-37, wherein a syntax element in the bitstream indicates whether to use the conditional context network or a further conditional context network with a structure different from the conditional context network.

Clause 39. The method of any of clauses 26-38, wherein a flag in the bitstream indicates that the conditional context network is applied to at least one of: luma or chroma.

Clause 40. The method of any of clauses 1-38, wherein a stride of convolution of at least one convolutional layer in the multistage context module is an integer greater than or equal to 2.

Clause 41. The method of any of clauses 1-40, wherein information regarding whether to and/or how to apply the method is indicated at at least one of: a block level, a sequence level, a group of pictures level, a picture level, a slice level, or a tile group level.

Clause 42. The method of any of clauses 1-41, wherein information regarding whether to and/or how to apply the method is included in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

Clause 43. The method of any of clauses 1-42, wherein information regarding whether to and/or how to apply the method is based on coded information, the coded information comprising at least one of: a block size, a color format, a single or dual tree partitioning, a color component, a slice type or a picture type.

Clause 44. The method of any of clauses 1-43, wherein the method is used in a coding tool requires chroma fusion.

Clause 45. The method of any of clauses 1-44, wherein a syntax element in the bitstream is binarized as at least one of: a flag, a fixed length code, an exponential Golomb (EG) (x) code, a unary code, a truncated unary code, or a truncated binary code, and wherein the syntax element is signed or unsigned.

Clause 46. The method of any of clauses 1-45, wherein a syntax element in the bitstream is coded with at least one context model, or bypass coded.

Clause 47. The method of any of clauses 1-46, wherein a syntax element is included in the bitstream based on a condition, the condition comprising at least one of: that a function associated with the syntax element is applicable, or that a dimension of the current video block satisfied a dimension condition.

Clause 48. The method of any of clauses 1-47, wherein a syntax element in the bitstream is at at least one of: a block level, a sequence level, a group of pictures level, a picture level, a slice level, or a tile group level.

Clause 49. The method of any of clauses 1-48, wherein a syntax element in the bitstream is included in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

Clause 50. The method of any of clauses 1-49, wherein the conversion comprises decoding the current visual unit from the bitstream.

Clause 51. The method of any of clauses 1-49, wherein the conversion comprises encoding the current visual unit into the bitstream.

Clause 52. An apparatus for visual data processing comprising a processor and a non-transitory memory with instructions thereon, wherein the instructions upon execution by the processor, cause the processor to perform a method in accordance with any of clauses 1-51.

Clause 53. A non-transitory computer-readable storage medium storing instructions that cause a processor to perform a method in accordance with any of clauses 1-51.

Clause 54. A non-transitory computer-readable recording medium storing a bitstream of visual data which is generated by a method performed by an apparatus for visual data processing, wherein the method comprises: determining a probability representation of a current visual unit of the visual data based on a multistage context module; and generating the bitstream based on the probability representation, wherein the multistage context module at least comprises at least one prediction fusion network, and wherein the number of convolutional layers in the at least one prediction fusion network is less than or equal to a first threshold number.

Clause 55. A method for storing a bitstream of visual data, comprising: determining a probability representation of a current visual unit of the visual data based on a multistage context module; generating the bitstream based on the probability representation; and storing the bitstream in a non-transitory computer-readable recording medium, wherein the multistage context module at least comprises at least one prediction fusion network, and wherein the number of convolutional layers in the at least one prediction fusion network is less than or equal to a first threshold number.

### Example Device

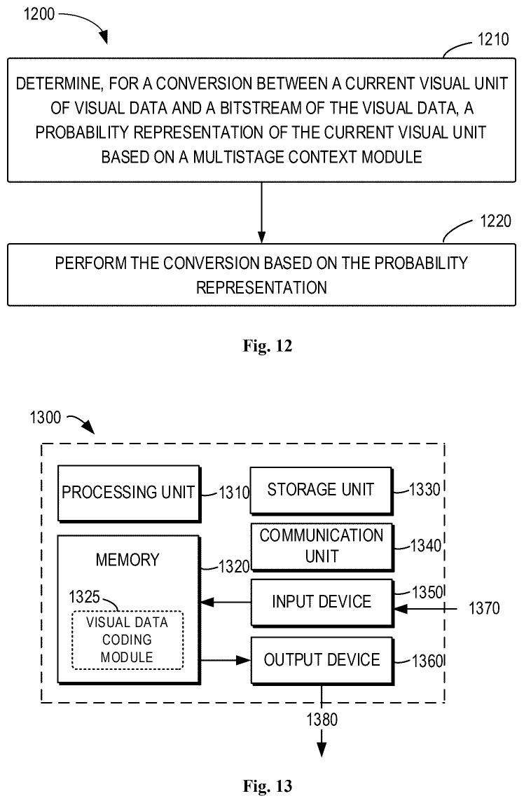

FIG. 13 illustrates a block diagram of a computing device 1300 in which various embodiments of the present disclosure can be implemented. The computing device 1300 may be implemented as or included in the source device 110 (or the data encoder 114) or the destination device 120 (or the data decoder 124).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement visual data encoding/decoding in embodiments of the present disclosure. The memory 1320 may include one or more visual data coding modules 1325 having one or more program instructions. These modules are accessible and executable by the processing unit 1310 to perform the functionalities of the various embodiments described herein.

In the example embodiments of performing visual data encoding, the input device 1350 may receive visual data as an input 1370 to be encoded. The visual data may be processed, for example, by the visual data coding module 1325, to generate an encoded bitstream. The encoded bitstream may be provided via the output device 1360 as an output 1380.

In the example embodiments of performing visual data decoding, the input device 1350 may receive an encoded bitstream as the input 1370. The encoded bitstream may be processed, for example, by the visual data coding module 1325, to generate decoded visual data. The decoded visual data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
determining, for a conversion between a current visual unit of visual data and a bitstream of the visual data, a probability representation of the current visual unit based on a multistage context module; and
performing the conversion based on the probability representation,
wherein the multistage context module at least comprises at least one prediction fusion network, and wherein the number of convolutional layers in the at least one prediction fusion network is less than or equal to a first threshold number.

2. The method of claim 1, wherein the number of channels in at least one convolutional layer in the at least one prediction fusion network is less than or equal to a second threshold number, or
wherein the number of channels in at least one convolutional layer in the at least one prediction fusion network is larger than or equal to a second threshold number.

3. The method of claim 1, wherein at least one activation layer in the at least one prediction fusion network is different from a first activation layer, and/or
wherein the at least one activation layer comprises a unified activation function, the unified activation function comprising one of: ReLU, LeakyReLU, GELU, or Sigmoid.

4. The method of claim 1, wherein at least one parameter of the at least one convolutional layer in the at least one prediction fusion network is different from at least one parameter of a first convolutional layer.

5. The method of claim 1, wherein the at least one prediction fusion network comprises a plurality of prediction fusion networks for a plurality of stages, and structures of the plurality of prediction fusion networks are same,
wherein for visual data representations in the plurality of stages, weights of the plurality of prediction fusion networks are different for respective stage operations, or wherein for visual data representations in the plurality of stages, weights of the plurality of prediction fusion networks are same for respective stage operations.

6. The method of claim 5, wherein at least one layer in a prediction fusion network of the plurality of prediction fusion networks is removed, or
wherein the number of channels of at least one convolutional layer in the plurality of prediction fusion networks is a multiple of a positive integer, wherein the positive integer is 16 or 32, or
wherein the number of channels of at least one convolutional layer in the plurality of prediction fusion networks is 2ⁿ, n being a positive integer.

7. The method of claim 1, wherein a plurality of prediction fusion network structures is supported, a first syntax element in the bitstream indicating a target prediction fusion network structure of the plurality of prediction fusion network structures to be used for the at least one prediction fusion network,
wherein a second syntax element in the bitstream indicates the number of the plurality of prediction fusion network structures.

8. The method of claim 1, wherein a syntax element in the bitstream indicates whether to use the at least one prediction fusion network or a further prediction fusion network with a structure different from the at least one prediction fusion network, and/or
wherein a flag in the bitstream indicates that the at least one prediction fusion network is applied to at least one of: luma or chroma.

9. The method of claim 1, wherein the multistage context module further comprises at least one multistage context network,
wherein the number of channels in the at least one multistage context network is less than or equal to a third threshold number,
wherein an input channel and an output channel of the multistage context network are updated, or wherein the number of channels is updated based on a change of input information.

10. The method of claim 9, wherein a kernel size of the at least one multistage context network is greater than or equal to a threshold size, wherein the kernel size is 4×4,
wherein the at least one multistage context network applies a first multistage mask convolutional pattern different from a second multistage mask convolutional pattern, and/or
wherein the multistage context network comprises four stages or nine stages.

11. The method of claim 1, wherein the multistage context module further comprises a conditional context network, and wherein the number of convolutional layers in the conditional context network is less than or equal to a fourth threshold number.

12. The method of claim 11, wherein the number of channels in at least one convolutional layer in the conditional context network is less than or equal to a threshold number, or
wherein the number of channels in at least one convolutional layer in the conditional context network is larger than or equal to a threshold number, or
wherein the number of channels in at least one convolutional layer in the conditional context network is one of: a multiple of M, M being 16 or 32, or 2ⁿ, n being a positive integer.

13. The method of claim 11, wherein at least one activation layer in the conditional context network is different from a first activation layer, wherein the at least one activation layer comprises a unified activation function, the unified activation function comprising one of: ReLU, LeakyReLU, GELU, or Sigmoid.

14. The method of claim 11, wherein at least one parameter of at least one convolutional layer in the conditional context network is different from at least one parameter of a first convolutional layer, or
wherein for a plurality of groups of latents grouped by a channel dimension, the conditional context network with a same structure and different weights is used to process latents of respective groups, or
wherein for a plurality of groups of latents grouped by a channel dimension, the conditional context network with a same structure and same weights is used to process latents of respective groups.

15. The method of claim 11, wherein a kernel size of a convolutional layer in the conditional context network comprises 4×4, and/or
wherein a plurality of conditional context network structures is supported, a syntax element in the bitstream indicating a target conditional context network structure to be used for the conditional context network, wherein a further syntax element in the bitstream indicated the number of the plurality of conditional context network structures, and/or
wherein a syntax element in the bitstream indicates whether to use the conditional context network or a further conditional context network with a structure different from the conditional context network, and/or
wherein a flag in the bitstream indicates that the conditional context network is applied to at least one of: luma or chroma.

16. The method of claim 1, wherein a stride of convolution of at least one convolutional layer in the multistage context module is an integer greater than or equal to 2.

17. The method of claim 1, wherein the conversion comprises decoding the current visual unit from the bitstream, or
wherein the conversion comprises encoding the current visual unit into the bitstream.

18. An apparatus for visual data processing comprising a processor and a non-transitory memory with instructions thereon, wherein the instructions upon execution by the processor, cause the processor to:
determine, for a conversion between a current visual unit of visual data and a bitstream of the visual data, a probability representation of the current visual unit based on a multistage context module; and
perform the conversion based on the probability representation,
wherein the multistage context module at least comprises at least one prediction fusion network, and wherein the number of convolutional layers in the at least one prediction fusion network is less than or equal to a first threshold number.

19. A non-transitory computer-readable storage medium storing instructions that cause a processor to perform acts comprising:
determining, for a conversion between a current visual unit of visual data and a bitstream of the visual data, a probability representation of the current visual unit based on a multistage context module; and
performing the conversion based on the probability representation,
wherein the multistage context module at least comprises at least one prediction fusion network, and wherein the number of convolutional layers in the at least one prediction fusion network is less than or equal to a first threshold number.

20. A non-transitory computer-readable recording medium storing a bitstream of visual data which is generated by a method performed by an apparatus for visual data processing, wherein the method comprises:
determining a probability representation of a current visual unit of the visual data based on a multistage context module; and
generating the bitstream based on the probability representation,
wherein the multistage context module at least comprises at least one prediction fusion network, and wherein the number of convolutional layers in the at least one prediction fusion network is less than or equal to a first threshold number.
